(19) United States
(12) Patent Application Publication
(10) Pub. No.: US 2013/0081993 A1
(43) Pub. Date: Apr. 4, 2013

(54) IRRIGATION SYSTEM FILTERS

(71) Applicant: Anthony Freakes, Skillman, NJ (US)

(72) Inventor: Anthony Freakes, Skillman, NJ (US)

(21) Appl. No.: 13/630,994

(22) Filed: Sep. 28, 2012

Related U.S. Application Data
(60) Provisional application No. 61/540,835, filed on Sep. 29, 2011.

(51) Int. Cl. B01D 35/02

(52) U.S. Cl. CPC B01D 35/02
USPC 210/351; 210/459; 210/352; 210/494.1

(57) ABSTRACT

Filters are disclosed in the form of a helical or spiral element operable to be contained in a pipe fitting, or device to be protected, such as a valve, sprinkler or the like. Filters including devices for adjusting the pitch of the filter and devices for clearing clogs in the filter are disclosed. Plumbing fixtures including a filter element are disclosed as well as devices for adjusting the pitch of the filter and devices for clearing clogs in the filter.

### CROSS-REFERENCE TO RELATED APPLICATIONS

This application claims the benefit of U.S. Provisional Patent Application Ser. No. 61/540,835, filed Sep. 29, 2011, the entirety of which is incorporated by reference herein.

### FIELD OF THE INVENTION

The invention relates to the field of filters. More specifically, it relates to simplified, low cost, easily cleanable filters, particularly those used in connection with irrigation systems.

### BACKGROUND OF THE INVENTION

When irrigating farms, golf courses, parks or any large expanse of land, the source of the irrigation water is frequently a river, stream, lake, pond or rain water cistern. This water naturally contains silts and vegetation matter, which could clog or jam the mechanical devices, such as valves and sprinklers, through which the water must travel and distribute.

The current art uses woven metal filters, usually formed into a hat shape, which fits into a specially designed cavity in a fitting, such as a valve or sprinkler, the cavity formed for the purpose of accommodating the woven filter. Woven metal is composed of wires arranged in a mesh. Therefore, as the wires occupy a certain percentage of the filter area, the open space through which the water flows is limited. Although these filters perform satisfactorily, they require frequent cleaning as the dirt will clog the filter and reduce the amount of flowing water. Also, such filters must be specially made, requiring special expensive tooling. This, along with the maintenance, tends to make these filters costly.

### SUMMARY OF THE INVENTION

In accordance with one embodiment a filter element is disclosed which is in the form of a helical or spiral element operable to be contained in a pipe fitting, or device to be protected, such as a valve, sprinkler or the like.

In one embodiment a filter element employs one or more wires wound helically or spirally, as in the spring maker's art. The pitch between the coils and the diameter of the wire defines the filter opening and particle limiting size. The filter element may be configured similar to a simple compression spring, or be a more complex combination of spiral flanges and straight, tapered or barreled helical windings. One skilled in the art will recognize variations in size, dimension, pitch openings and the like may be made without departing from the spirit and scope of the presently disclosed subject matter.

The filter element may be contained in a pipe fitting, preferably preceding a device to be protected, or built into or fitted in the protected device. The fitting may or may not require special designing or machining to accommodate and ensure sufficient water flow, and can be configured much the same as fittings presently available. For example, in one embodiment a fitting may be an elbow fitting configured to accommodate the filter element. As will be apparent to the skilled artisan this embodiment is among the simplest of possible fittings. Many other fittings may be employed. For example, any fitting that precedes a device to be protected may be fitted with a filter fitting as described herein. Such fittings include but are not limited to tee joints, straight pipe sections, U joints, cross joints and the like.

The filter element may also be employed in a device to be protected, such as a valve, sprinkler or other device. In one embodiment the disclosed filters may be employed in every device that is part of a system, such as in a sprinkler system of a golf course. In another embodiment, the disclosed filters may be employed in fittings preceding every device in a system.

In accordance with another embodiment a plumbing fitting is disclosed which consists of or comprises a filter as disclosed and described herein.

In accordance with one embodiment, a plumbing fitting is disclosed including a filter disposed in a bore of said fitting, the filter having one or more wires wound helically or spirally, wherein a pitch between coils and a diameter of the one or more wires define a filter opening. The plumbing fitting may be a pipe fitting, valve, tee joint, straight pipe section, U joint, cross joint or elbow fitting. The plumbing fitting may be a sprinkler head.

In accordance with another embodiment a fitting is provided in which the pitch between the coils in the filter element is adjustable, thus changing the particle size filtered, without disassembly of the fitting from the plumbing system. The plumbing fitting may include a filter adjustment device operable to compress and release the filter, the filter adjustment device including a rotatable element operably engaged to the filter through a bore in the fitting, wherein rotation of the rotatable element in one direction is operable to compress the filter.

In accordance with yet a further embodiment, a clog clearing device is provided so that clogs may be cleared from the filter element without disassembly of the fitting and filter element, making maintenance more efficient. In one embodiment a plumbing fitting may essentially comprise a clearing element including a plunger disposed within the fitting and an interior circumference of the filter, the plunger operably connected to a stem extending from the fitting, wherein the plunger is moveable with respect to the filter and in response to the movement of the stem. The stem may be rotatable.

In another embodiment a filter for a plumbing fixture is provided including one or more wires wound helically or spirally, wherein a pitch between coils and a diameter of the one or more wires define a filter opening, the filter operably connected to a filter adjustment device operable to adjust the pitch between the coils. The filter may be a compressible spring. The filter adjustment device may be operable to compress and release the filter, the filter adjustment device comprising essentially a rotatable element operably engaged to the filter, wherein rotation of the rotatable element in one direction is operable to compress the filter.

In yet a further embodiment, a filter for a plumbing fixture may include one or more wires wound helically or spirally, wherein a pitch between coils and a diameter of the one or more wires define a filter opening, the filter operably connected to a clearing element having a plunger disposed within an interior circumference of the filter, the plunger operably connected to a stem extending therefrom, wherein the plunger is moveable with respect to the filter and in response to the movement of the stem. The stem may be rotatable.

Advantages of the disclosed subject matter include that the filter fittings disclosed herein may be produced at lower cost than a mesh type filter. Also, the disclosed subject matter is more flexible in application. A pipe fitting containing the disclosed filter need not be larger than normal fittings, and can simply replace an existing normal fitting. Cleaning and changing the filter is simple and fast and this cleaning is not needed as frequently as when using a mesh-type filter. The filter element can be precisely set to the desired particle size limit and is very robust and will last an extremely long time. Cleaning can be accomplished by simply removing the fitting, flushing and replacing, all done in less than two minutes.

The disclosed filters are so cost effective that they can be deployed as protection before every delicate device in a given system. One such filter may be used to protect many devices, if the filter is placed strategically.

It is believed certain embodiments of the disclosed subject matter can filter three times the amount of fluid than that of an equivalent sized “mesh” filter. This means that if a “mesh” filter clogs 50% in a month, then a filter in accordance with the present disclosure may last seven times longer.

The presently disclosed filters can be incorporated within any device which needs close filtering.

Given above is a simplified summary in order to provide a basic understanding of some aspects described herein. This summary is not an extensive overview, and is not intended to identify key/critical elements or to delineate the scope of the claimed subject matter.

### BRIEF DESCRIPTION OF THE DRAWINGS

So that those having ordinary skill in the art will have a better understanding of how to make and use the disclosed systems and methods, reference is made to the accompanying figure wherein:

FIG. 1 is a perspective view of a fitting and filter according to one embodiment of the disclosed subject matter;

FIG. 2 is a perspective view of a hat filter element in accordance with one embodiment of the disclosed subject matter;

FIG. 3 is a perspective view of a hat filter element in accordance with one embodiment of the disclosed subject matter;

FIG. 4 is a perspective view of a hat filter element in accordance with one embodiment of the disclosed subject matter;

FIG. 5 is a perspective view of a compressed filter element in accordance with one embodiment of the disclosed subject matter;

FIG. 6 is a perspective view of a fitting having a filter element adjustment device; and

FIG. 7 is a perspective view of a fitting having a clog-clearing device.

### DETAILED DESCRIPTION OF THE INVENTION

The following is a detailed description of the invention provided to aid those skilled in the art in practicing the present invention. Those of ordinary skill in the art may make modifications and variations in the embodiments described herein without departing from the spirit or scope of the present invention. Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. All publications, patent applications, patents, figures and other references mentioned herein are expressly incorporated by reference in their entirety.

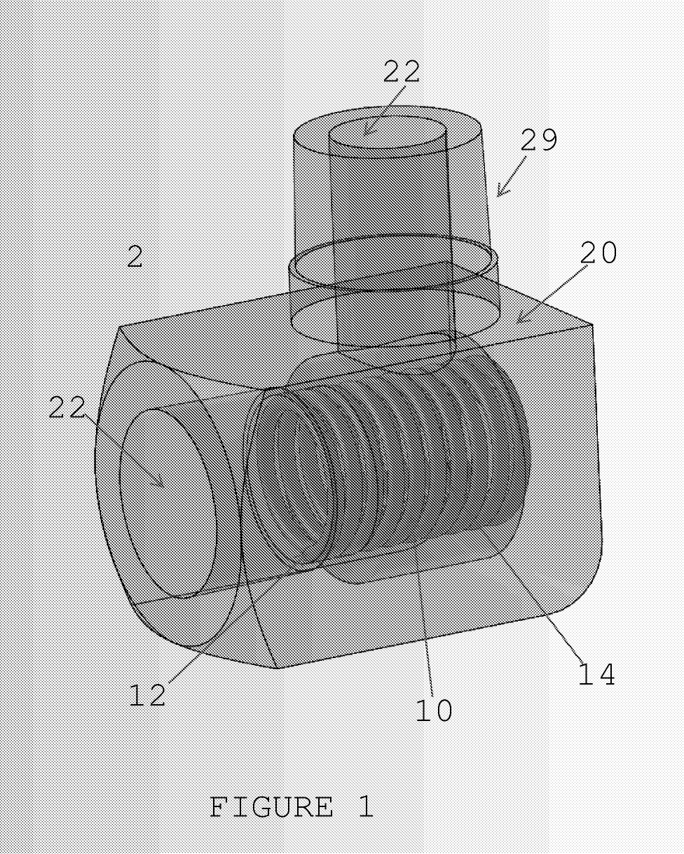

Now referring to FIG. 1, a filter fitting 2 includes a filter element 10 included in the interior portion of a fitting 20 and is capable of filtering material from a fluid stream passing through the bore 22 of the filter fitting 2. Fitting 20 may include one or more nipples 29.

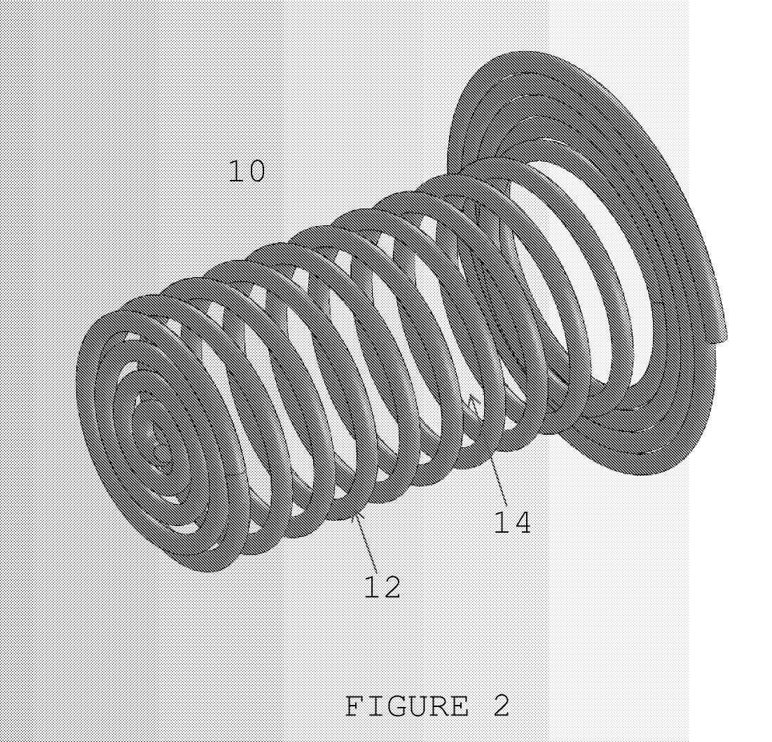

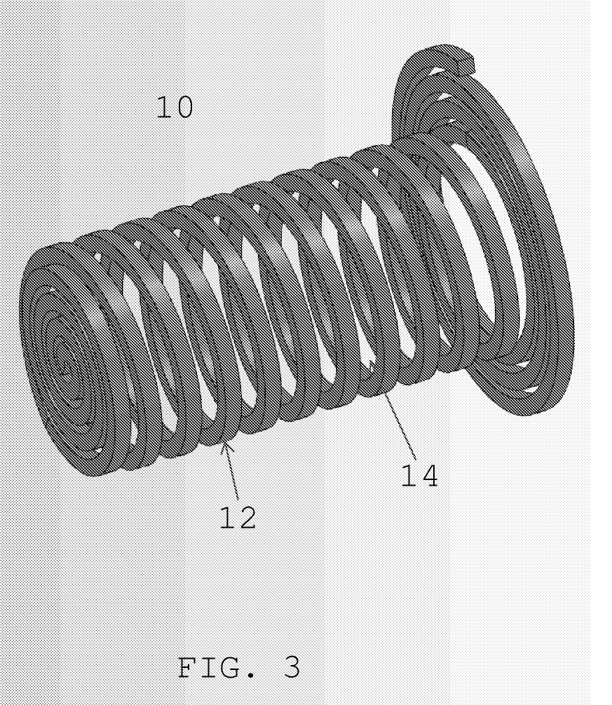

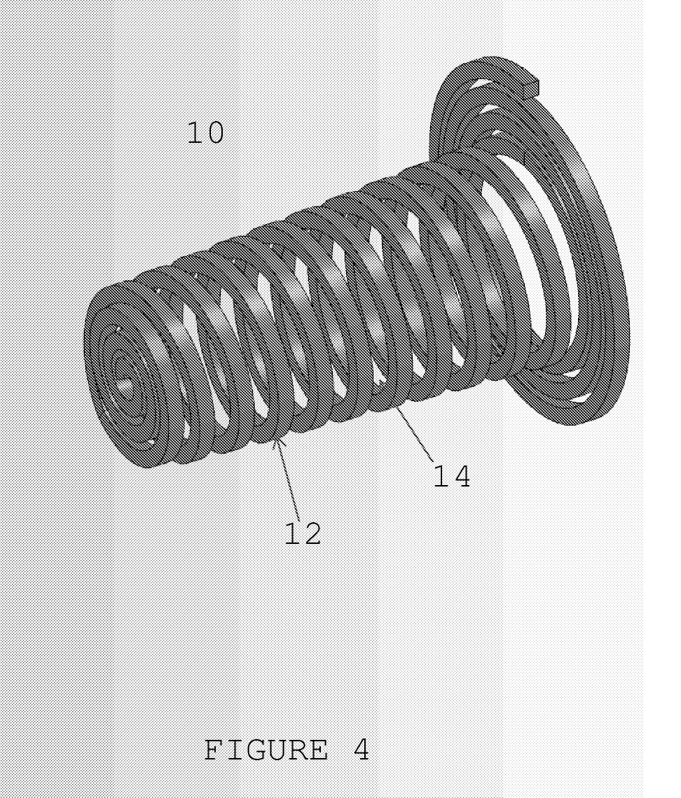

The filter element 10 may be constructed of at least one wire 12 wound helically or spirally, as in the spring maker's art. The pitch between the coils and the diameter of the wire 12 defines the filter opening 14 and hence particle limiting size. One skilled in the art will recognize the required size of the filter opening 14 for a given application, taking into account the water source and impurities to be filtered. The filter element 10 may be configured similar to a simple compression spring, or be a more complex combination of spiral flanges and straight, tapered or barreled helical windings. One skilled in the art will recognize variations in size, dimension, openings and the like may be made without departing from the spirit and scope of the presently disclosed subject matter. Wire 12 may be round, square or rectangular wire. Selection of the wire type is dictated by cost and dirt condition. Round wire has the lowest cost, but the sharp edge on square and rectangular wire tends to prevent dirt wedging between the coils. Now referring to FIGS. 2-4, various embodiments of filter element 10 are depicted. FIG. 2 shows a round wire filter having a hat filter configuration. As will be apparent to those skilled in the art the base portion of a hat filter may be employed to retain the filter in a fitting.

The filter element 10 may be contained in a fitting 20, or built into or fitted in a device to be protected, such as a valve, sprinkler or other device. In one embodiment the disclosed filters may be employed in every device that is part of a system, such as in a sprinkler system. In another embodiment, the disclosed filters may be employed in fittings preceding every device in a system.

Preferably, when the filter element 10 is not fitted with the protected device it may precede in line the protected device in the direction of fluid flow. The filter element 10 may be retained by the next element in the plumbing system. For example, a nipple or any other fitting which is assembled in the female pipe thread may hold the filter element 10 in place. The fittings and pipe which can fit into the female pipe thread may have a central bore which is smaller than the filter element 10, so that the filter element 10 is retained naturally so long as the fitting is connected to a plumbed system and fluid is flowing. When it is disconnected then the filter element 10 can be removed. When the fitting which is attached to the female pipe thread is removed, the filter element 10 simply falls out. If the filter element 10 is stuck, it can be removed by ordinary hand tools, or can be flushed out by reverse water flow.

A filter element 10 sized to fit in the bore of a fitting 20 may be installed simply by placing the filter element 10 in the bore of the fitting 20. The filter element 10 may be secured in place by connection of an adjacent fitting. The fitting 20 may or may not require special designing or machining to accommodate and ensure sufficient water flow, and can be configured much the same as fittings presently available. For example, a bore of a fitting may be increased in diameter, and include an interior lip, ridge or detent to retain a filter. In one embodiment a fitting may be an elbow fitting configured to accommodate the filter element 10. As will be apparent to the skilled artisan, many other fittings may be employed. Any fitting that precedes a device to be protected may be fitted with a filter fitting as described herein. Such fittings include but are not limited to tee joints, straight pipe sections, U joints, cross joints and the like.

In accordance with another embodiment a plumbing fitting is disclosed which consists of or comprises a filter fitting as disclosed and described herein.

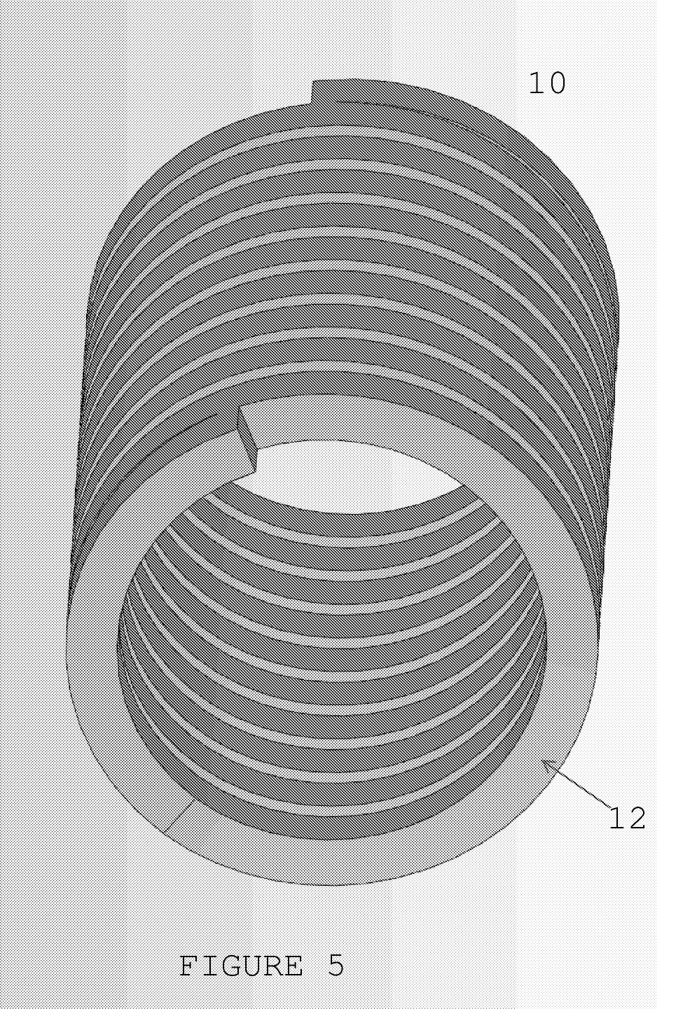

In accordance with another embodiment a fitting is provided in which the pitch between the coils in the filter element is adjustable, thus changing the particle size filtered, without disassembly of the fitting from the plumbing system. This embodiment may be accomplished by compressing or releasing the filter element. FIG. 5 depicts a compressed filter element 10 with square wire 12.

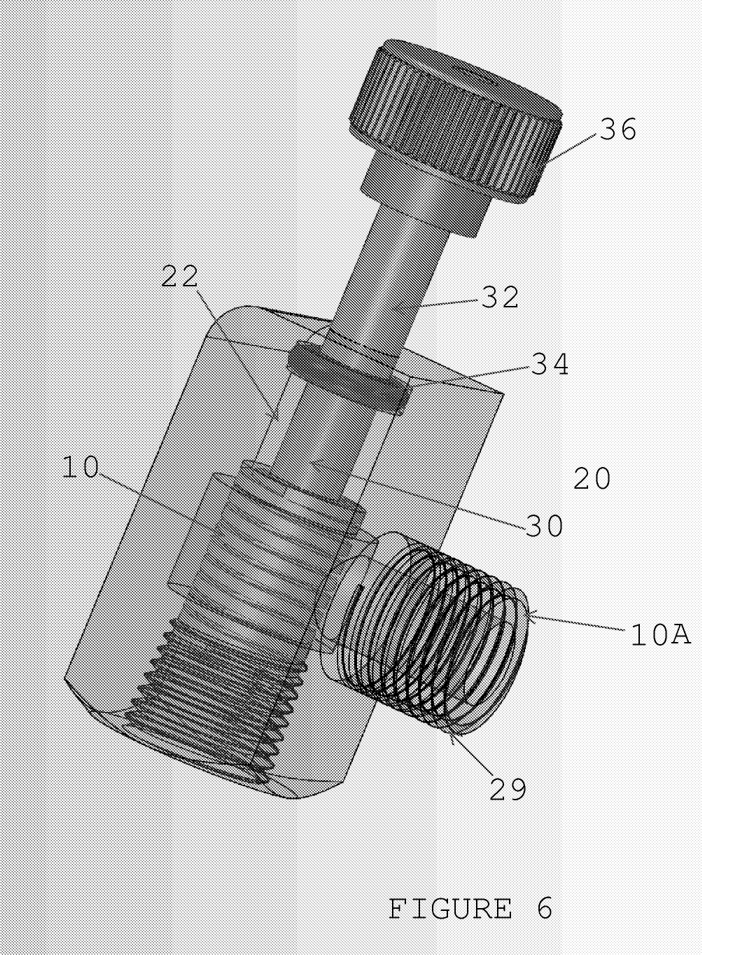

Now referring to FIG. 6, a fitting 20 includes a filter adjustment device 30 for compressing and releasing the filter element 10. Filter adjustment device 30 includes a stem 32 operably engaged to the fitting 20 through a bore 22 in the fitting 20. Adjustment device 30 may engage the filter element 10, and pass through the internal passage of the filter element 10. The bore 22 preferably includes a seal 34 such as an O ring. The stem 32 includes a thread at its external end and is adjustable by an external finger nut 36. Turning nut 36 in one direction compresses filter element 10 and in the other direction relaxes the filter element. Filter element 10A may be disposed in a nipple element 29 of fitting 20.

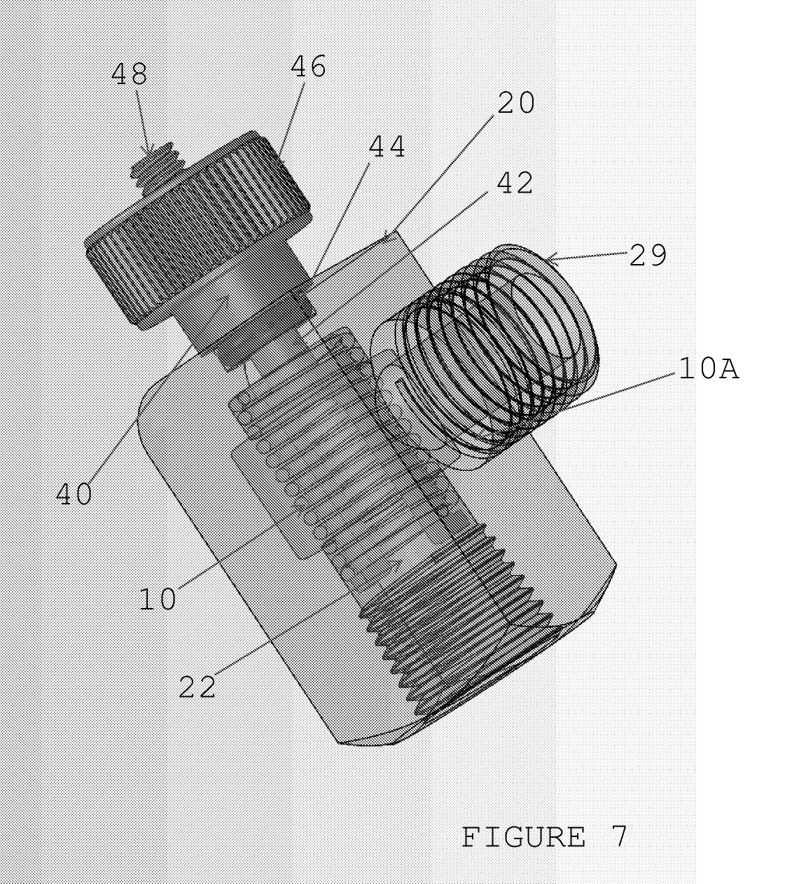

Now referring to FIG. 7, a clog clearing device 40 includes a plunger 42 operably engaged to the fitting 20 through a bore 22 in the fitting 20. The bore 22 preferably includes a seal 44 such as an O ring. Plunger 42 passes through the internal passage of the filter element 10. The clog cleaning device 40 may include a threaded end 48, and a finger nut 46 engaged to the threaded end 48. The plunger 40 is operable to move, and remove debris, as the nut 46 is turned, making maintenance more efficient. Clogs and debris may be removed from the filter element 10 without disassembly of the fitting 20 and filter element 10. Filter element 10A may be disposed in a nipple element 29 of fitting 20.

Although the systems and methods of the present disclosure have been described with reference to exemplary embodiments thereof, the present disclosure is not limited thereby. Indeed, the exemplary embodiments are implementations of the disclosed systems and methods are provided for illustrative and non-limitative purposes. Changes, modifications, enhancements and/or refinements to the disclosed systems and methods may be made without departing from the spirit or scope of the present disclosure. Accordingly, such changes, modifications, enhancements and/or refinements are encompassed within the scope of the present invention.

What is claimed is:

1. A plumbing fitting comprising a filter disposed in a bore of said fitting, the filter comprising one or more wires wound helically or spirally, wherein a pitch between coils and a diameter of the one or more wires define a filter opening.

2. The plumbing fitting according to claim 1 wherein the filter comprises a compressible spring.

3. The plumbing fitting according to claim 1 comprising a pipe fitting.

4. The plumbing fitting according to claim 1 wherein the fitting comprises a valve, tee joint, straight pipe section, U joint, cross joint or elbow fitting.

5. The plumbing fitting according to claim 1 wherein the fitting comprises a sprinkler head.

6. The plumbing fitting according to claim 1 comprising a filter adjustment device operable to adjust the pitch between the coils.

7. The plumbing fitting according to claim 1 comprising a filter adjustment device operable to compress and release the filter, the filter adjustment device comprising a rotatable element operably engaged to the filter through a bore in the fitting, wherein rotation of the rotatable element in one direction is operable to compress the filter.

8. The plumbing fitting according to claim 1 comprising a clearing element comprising a plunger disposed within the fitting and an interior circumference of the filter, the plunger operably connected to a stem extending from the fitting, wherein the plunger is moveable with respect to the filter and in response to the movement of the stem.

9. The plumbing fitting according to claim 8 wherein the stem is rotatable.

10. A filter for a plumbing fixture comprising one or more wires wound helically or spirally, wherein a pitch between coils and a diameter of the one or more wires define a filter opening, the filter operably connected to a filter adjustment device operable to adjust the pitch between the coils.

11. The filter according to claim 10 wherein the filter comprises a compressible spring.

12. The filter according to claim 10 wherein the filter adjustment device is operable to compress and release the filter, the filter adjustment device comprising a rotatable element operably engaged to the filter, wherein rotation of the rotatable element in one direction is operable to compress the filter.

13. A filter for a plumbing fixture comprising one or more wires wound helically or spirally, wherein a pitch between coils and a diameter of the one or more wires define a filter opening, the filter operably connected to a clearing element comprising a plunger disposed within an interior circumference of the filter, the plunger operably connected to a stem extending therefrom, wherein the plunger is moveable with respect to the filter and in response to the movement of the stem.

14. The filter according to claim 13 wherein the stem is rotatable.
